(19) United States
(12) Patent Application Publication
(10) Pub. No.: US 2022/0230096 A1
(43) Pub. Date: Jul. 21, 2022

(54) INFORMATION PROCESSING METHOD, INFORMATION PROCESSING DEVICE, AND PROGRAM

(71) Applicant: SONY GROUP CORPORATION, TOKYO (JP)

(72) Inventors: SHINGO TAKAMATSU, TOKYO (JP); MASANORI MIYAHARA, TOKYO (JP); HIROSHI IIDA, TOKYO (JP); KENTO NAKADA, TOKYO (JP); YUJI HORIGUCHI, TOKYO (JP)

(21) Appl. No.: 17/615,368

(22) PCT Filed: Jun. 1, 2020
(86) PCT No.: PCT/JP2020/021540

§ 371 Date: Nov. 30, 2021

(30) Foreign Application Priority Data
Jun. 11, 2019 (JP) 2019-108722

(51) Int. Cl. G06N 20/00; G06K 9/62

(52) U.S. Cl. CPC G06N 20/00; G06K 9/6261; G06K 9/6227; G06K 9/6215

(57) ABSTRACT

The present technology relates to an information processing method, an information processing device, and a program capable of improving prediction accuracy of a prediction model.

An information processing system including one or more information processing devices performs training of the prediction model on the basis of prediction data used for predictive analysis using the prediction model and learning data. Furthermore, the information processing system including one or more information processing devices performs the predictive analysis on the basis of the prediction model trained on the basis of the learning data and the prediction data, and the prediction data. The present technology can be applied to, for example, a system that performs the predictive analysis for various services.

### TECHNICAL FIELD

The present technology relates to an information processing method, an information processing device, and a program, and more particularly, to an information processing method, an information processing device, and a program for improving prediction accuracy of a prediction model.

### BACKGROUND ART

In recent years, predictive analysis has been used in various fields (see, for example, Patent Document 1). The predictive analysis is, for example, a technology of predicting a future event on the basis of a past result by machine learning.

### CITATION LIST

### Patent Document

### Patent Document 1: WO 2016/136056 A

### SUMMARY OF THE INVENTION

### Problems to be Solved by the Invention

However, there is a possibility that the accuracy of the predictive analysis decreases in a case where a feature of learning data used for training of a prediction model used for the predictive analysis is greatly different from a feature of prediction data actually used in the predictive analysis.

For example, in a case where a prediction model that predicts a behavior of a customer in a certain service is generated on the basis of learning data for the past one year, and the predictive analysis is performed on the basis of prediction data for the next month, there is a possibility that a feature of the learning data and a feature of the prediction data are greatly different in a case where a service situation has greatly changed in the past one year (for example, a significant change in service content, emergence of strong competitors, or the like). Further, there is a possibility that the accuracy of the predictive analysis deteriorates in a case where the feature of the learning data and the feature of the prediction data are significantly different from each other.

The present technology has been made in view of such a situation, and an object of the present technology is to improve prediction accuracy of a prediction model.

### Solutions to Problems

An information processing method according to an aspect of the present technology includes performing, by an information processing system including one or more information processing devices, training of a prediction model on the basis of prediction data used for predictive analysis using the prediction model and learning data.

An information processing device according to an aspect of the present technology includes a learning unit that performs training of a prediction model on the basis of prediction data used for predictive analysis using the prediction model and learning data.

A program according to an aspect of the present technology causes a computer to perform processing of performing training of a prediction model on the basis of prediction data used for predictive analysis using the prediction model and learning data.

According to an aspect of the present technology, training of a prediction model is performed on the basis of prediction data used for predictive analysis using the prediction model and learning data.

### BRIEF DESCRIPTION OF DRAWINGS

FIG. 1 is a block diagram illustrating an embodiment of an information processing system to which the present technology is applied.

FIG. 2 is a diagram illustrating an example of learning data and prediction data.

FIG. 3 is a flowchart for describing a first embodiment of learning processing.

FIG. 4 is a flowchart for describing details of learning data generation processing.

FIG. 5 is a diagram illustrating an example of a range of target customers of the learning data and target customers of the prediction data.

FIG. 6 is a flowchart for describing details of a one-of-k vector.

FIG. 7 is a flowchart for describing a first embodiment of prediction processing.

FIG. 8 is a flowchart for describing a second embodiment of the learning processing.

FIG. 9 is a graph illustrating an example of a prediction accuracy calculation result.

FIG. 10 is a flowchart for describing a third embodiment of the learning processing.

FIG. 11 is a flowchart for describing details of similarity degree calculation processing.

FIG. 12 is a graph illustrating an example of a similarity degree calculation result.

FIG. 13 is a flowchart for describing a fourth embodiment of the learning processing.

FIG. 14 is a flowchart for describing a second embodiment of the prediction processing.

FIG. 15 is a flowchart for describing a fifth embodiment of the learning processing.

FIG. 16 is a diagram illustrating an example of a setting screen.

FIG. 17 is a block diagram illustrating an example of a configuration of a computer.

### MODE FOR CARRYING OUT THE INVENTION

Hereinafter, modes for carrying out the present technology will be described. Descriptions will be provided in the following order.

1. First Embodiment

2. Second Embodiment

3. Third Embodiment

4. Fourth Embodiment

5. Fifth Embodiment

6. Modified Examples

7. Others

### 1. First Embodiment

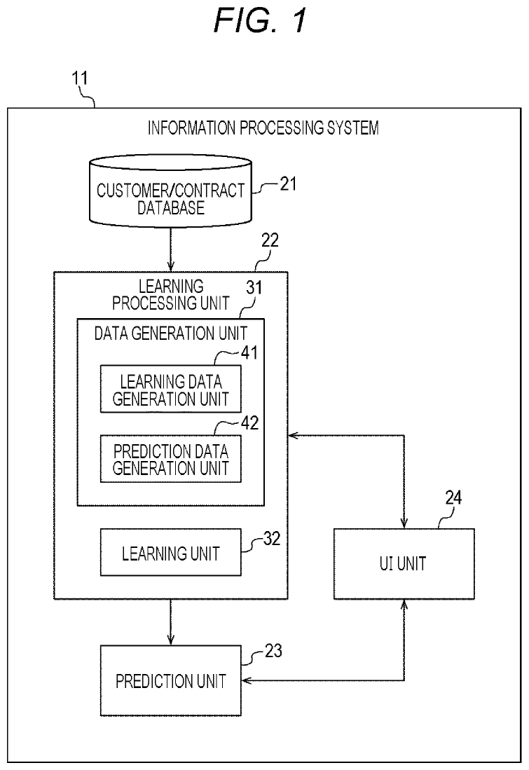

First, a first embodiment of the present technology will be described with reference to FIGS. 1 to 7.

<Example of Configuration of Information Processing System 11>

FIG. 1 illustrates an example of a configuration of an information processing system 11 to which the present technology is applied.

The information processing system 11 is a system that performs predictive analysis related to various services. The information processing system 11 includes a customer/contract database 21, a learning processing unit 22, a prediction unit 23, and a user interface (UI) unit 24.

The customer/contract database 21 is a database that stores data regarding a customer who uses a service and a contract.

The learning processing unit 22 performs learning processing for a prediction model used for the predictive analysis related to various services. The learning processing unit 22 includes a data generation unit 31 and a learning unit 32.

The data generation unit 31 includes a learning data generation unit 41 and a prediction data generation unit 42.

The learning data generation unit 41 generates learning data used for training of the prediction model on the basis of the data stored in the customer/contract database 21.

The prediction data generation unit 42 generates prediction data used for the predictive analysis using the prediction model on the basis of the data stored in the customer/contract database 21. The prediction data generation unit 42 supplies the generated prediction data to the prediction unit 23.

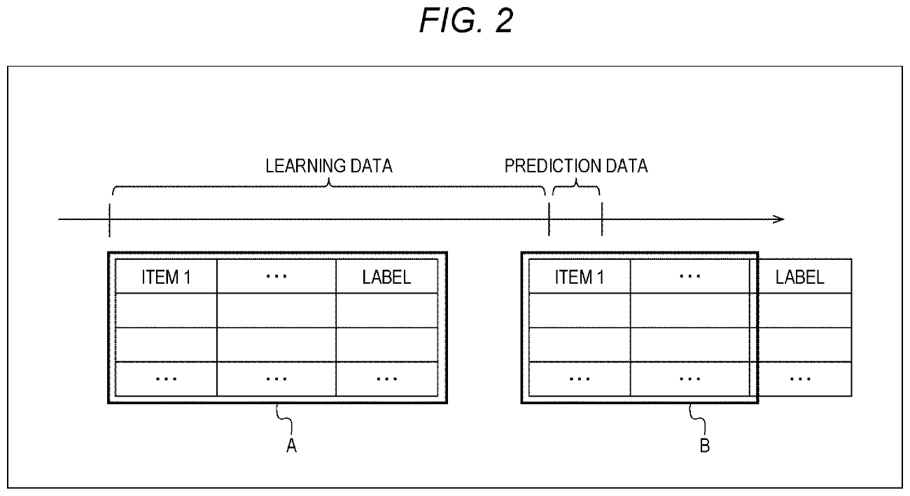

FIG. 2 illustrates an example of the learning data and the prediction data. Learning data A includes input data indicating values for one or more predetermined items and a label indicating a correct answer of a target predicted by the prediction model. On the other hand, prediction data B includes input data of the same items as those of the learning data A, but does not include the label.

The learning unit 32 performs training of the prediction model on the basis of the learning data and the prediction data to generate the prediction model. That is, in learning processing according to the related art, training of the prediction model is performed on the basis of only the learning data A of FIG. 2; however, as will be described later, the learning unit 32 performs the training of the prediction model by using the prediction data as necessary in addition to the learning data. As a consequence, the prediction accuracy of the prediction model is improved. The learning unit 32 supplies the generated prediction model to the prediction unit 23.

The prediction unit 23 performs the predictive analysis related to various services on the basis of the prediction model and the prediction data. For example, the prediction unit 23 performs behavior prediction for a customer who uses a service, demand prediction for the service, and the like.

The UI unit 24 provides a user interface for a user (for example, a service provider) who uses the information processing system 11. For example, the UI unit 24 receives an input from the user and presents, to the user, information for using the information processing system 11, a result of training performed by the learning unit 32, and a prediction result of the prediction unit 23.

Note that, hereinafter, processing performed by the information processing system 11 will be explained by using a specific example in which prediction of withdrawal of a customer is performed in order to improve the efficiency and effect of a telephone support service performed to reduce the withdrawal of the customer from a flat-rate music distribution service.

It is inefficient to perform the telephone support service for all customers because of high costs such as high labor costs. Therefore, for example, it is efficient to predict a probability of withdrawal from the service on the basis of an attribute, behavior, or the like of the customer by machine learning and perform the telephone support service only for a customer having a high withdrawal probability. In addition, it is expected that higher prediction accuracy of the withdrawal probability of the customer can reduce the number of customers who will withdraw.

Note that, hereinafter, it is assumed that a subscription period of the flat-rate music distribution service is one year, and the customer determines whether to renew or withdraw from the subscription every year. In addition, it is assumed that a period for the customer to make a decision as to whether to renew or withdraw from the contract is within one month from a contract renewal date. Note that it is assumed that the contract renewal date is set to the same date as a contract date every year. For example, in a case where the contract date is May 1, 2017, the next contract renewal date is set to May 1, 2018, and the second next contract renewal date is set to May 1, 2019.

In addition, hereinafter, it is assumed that a withdrawal probability of a customer whose contract renewal date for the next month (for example, May of 2019) is at the end of each month (for example, Apr. 30, 2019) is predicted, and a call is made for a predetermined number of customers whose withdrawal probability is high or customers whose withdrawal probability is equal to or greater than a predetermined threshold value to urge the customers to renew the contract in order to prevent the withdrawal.

Note that, hereinafter, a customer whose contract renewal date is in a certain period is referred to as a renewal target of the period. For example, a customer whose contract renewal date is in May of 2019 is referred to as a renewal target of May of 2019.

Moreover, hereinafter, it is assumed that the customer/contract database 21 stores data including customer information and service contract information.

The customer information is information indicating a characteristic of the customer, and includes, for example, an attribute of the customer and information based on a customer behavior log on the service. For example, the customer information includes the age, gender, address, music listened in the past, genre of music frequently listened to, and the like of the customer. The service contract information is information regarding a content of a contract with the customer, and includes, for example, a contract date, a contract renewal date, a withdrawal date, a payment method, and the like.

<First Embodiment of Learning Processing>

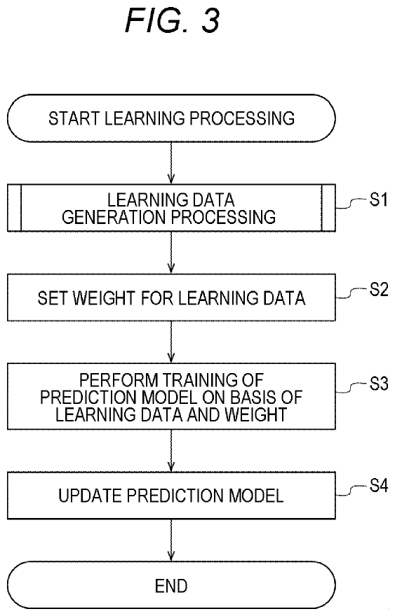

Next, a first embodiment of learning processing performed by the information processing system 11 will be described with reference to a flowchart of FIG. 3.

Note that a case where a withdrawal probability of a renewal target of May of 2019 is predicted will be described below as an example. That is, a case where the current date is Apr. 30, 2019, and the withdrawal probability of the customer whose contract renewal date is within a period from May 1, 2019 to May 31, 2019 is predicted will be described as an example.

Note that, hereinafter, a period for which the withdrawal probability is predicted is referred to as a prediction period. In this example, a period from May 1, 2019 to May 31, 2019 is the prediction period. Furthermore, in a case where the prediction period is set on a monthly basis, the prediction period is also referred to as a target prediction month. In this example, May of 2019 is the target prediction month.

In Step S1, the learning data generation unit 41 performs learning data generation processing.

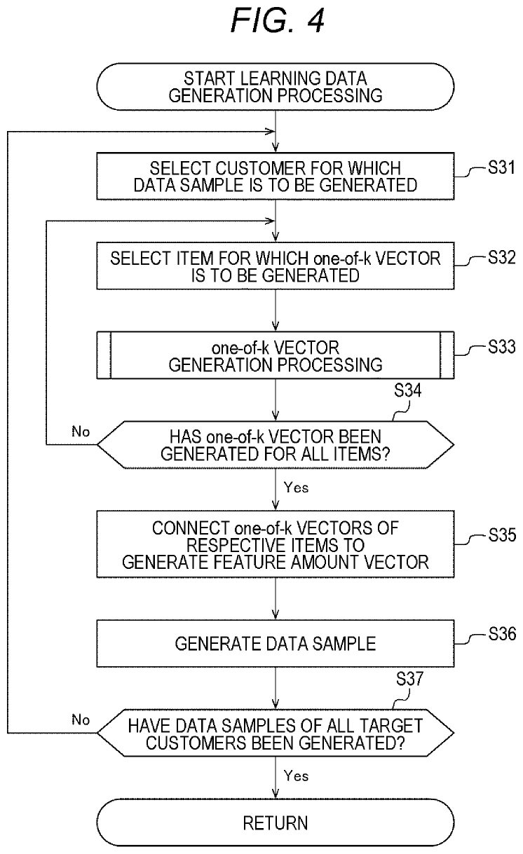

Here, details of the learning data generation processing will be described with reference to a flowchart of FIG. 4.

In Step S31, the learning data generation unit 41 selects a customer for which a data sample is to be generated. The learning data includes a set of data samples generated for the respective customers. Then, the learning data generation unit 41 selects one customer for which the data sample has not been generated yet from among customers satisfying a predetermined condition in the customer/contract database 21.

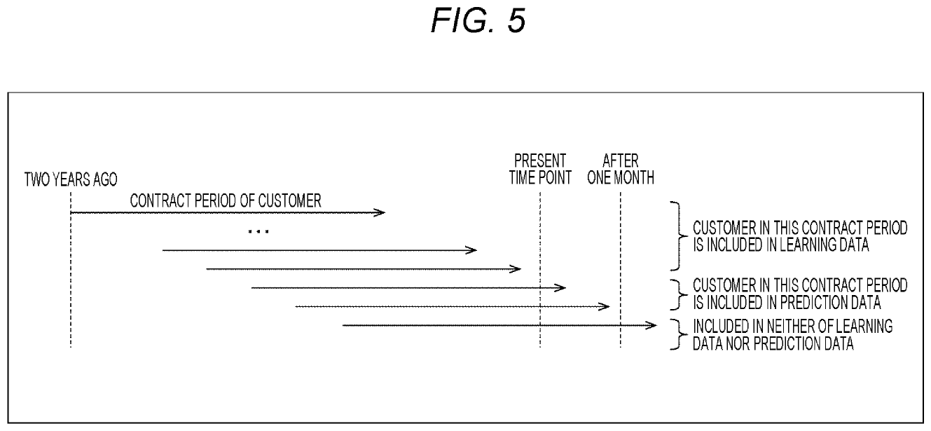

Note that, hereinafter, it is assumed that the renewal target in the past one year is the target of the learning data as illustrated in FIG. 5. That is, it is assumed that the learning data is generated on the basis of the customer information in a contract period of a customer whose contract period has expired and whose contract renewal date has come in the past one year.

In addition, hereinafter, a period for which the learning data is generated and the prediction model is trained is referred to as a learning period. Therefore, the learning data is generated on the basis of the customer information of the renewal target in the learning period, and the prediction model is learned on the basis of the generated learning data. In this example, the past one year is the learning period.

Moreover, hereinafter, it is assumed that the renewal target within the next one month is the target of the prediction data. That is, it is assumed that the prediction data is generated on the basis of the customer information in a contract period of a customer whose contract period is to expire and whose contract renewal date comes in the next one month.

Therefore, in this example, the renewal target in the period (learning period) from May 1, 2018 to Apr. 30, 2019 is included in the learning data. That is, the learning data is generated on the basis of the customer information in the contract period of the renewal target within the period.

In addition, the renewal target in the period (prediction period) from May 1, 2019 to May 31, 2019 is included in the prediction data. That is, the prediction data is generated on the basis of the customer information in the contract period of the renewal target in the period.

Note that a renewal target who is the renewal target in the period from May 1, 2018 to May 31, 2018 and who has renewed the contract is a target of both the learning data and the prediction data. However, the customer information in the previous contract period of the renewal target is the target of the learning data, and the customer information in the current contract period of the customer is the target of the prediction data.

In addition, a customer who has subscribed after Jun. 1, 2018 is not included in either the learning data or the prediction data. That is, the customer is neither the target of the learning data nor the target of the prediction data.

Hereinafter, the customer selected in the processing of Step S31 is referred to as a customer of interest.

In Step S32, the learning data generation unit 41 selects an item for which a one-of-k vector is to be generated. The learning data generation unit 41 selects one item for which the one-of-k vector has not been generated yet from among items which are targets of a feature amount vector of the customer information of the customer of interest in the customer/contract database 21. The one-of-k vector is a k-dimensional vector, and is a vector in which a value of only one element is 1 and values of the remaining k−1 elements are 0.

Hereinafter, the item selected in the processing of Step S32 is referred to as an item of interest.

In Step S33, the learning data generation unit 41 performs one-of-k vector generation processing.

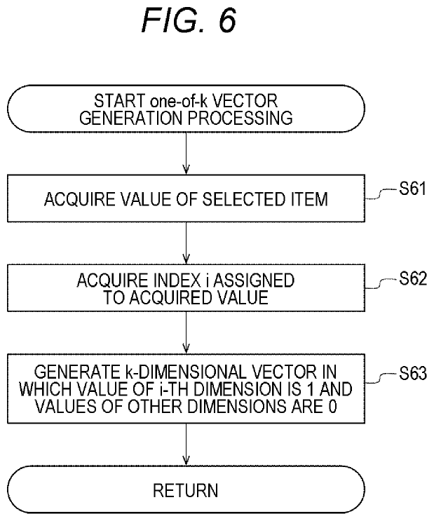

Here, details of the one-of-k vector generation processing will be described with reference to a flowchart of FIG. 6.

In Step S61, the learning data generation unit 41 acquires a value of the selected item (item of interest). That is, the learning data generation unit 41 acquires the value of the item of interest from the customer information of the customer of interest in the customer/contract database 21.

Note that each item of the customer information is represented by, for example, a categorical value (for example, gender, address, or the like) or a continuous value (for example, age, the number of times music is played within a month, or the like).

In Step S62, the learning data generation unit 41 acquires an index i assigned to the acquired value.

For example, in a case where the item of interest can have k types of values, different indexes from 1 to k are assigned to the respective values in advance.

For example, in a case where the item of interest is age and a possible value range is from 18 to 99, an index from 1 to 82 is assigned to each value from 18 to 99. Then, in a case where the age of the customer of interest is 20, an index 3 is acquired.

For example, in a case where the item of interest is a genre of music and is classified into k kinds of genres, an index from 1 to k is assigned to each genre.

Furthermore, for example, the values of the item of interest may be divided into k groups, and an index from 1 to k may be assigned to each group.

For example, in a case where the item of interest is age, ages are divided into a group of less than 10 years old, a group of teens, a group of twenties, . . . , a group of 90s, and a group of 100 years old or more, and an index from 1 to 11 is assigned to each age group.

For example, in a case where the item of interest has continuous values, a range between a maximum value and a minimum value of the item of interest is equally divided into k, and an index from 1 to k is assigned to each range.

In Step S63, the learning data generation unit 41 generates a k-dimensional vector in which a value of the i-th dimension is 1 and values of other dimensions are 0.

For example, in the above-described example in which the item of interest is age, in a case where the age of the customer is 20, an 82-dimensional one-of-k vector in which a value of the third dimension is 1 and values of other dimensions are 0 is generated.

Note that, for example, in a case where the value of the item of interest of the customer of interest is outside an assumed range or in a case where the value of the item of interest of the customer of interest is missing, the one-of-k vector in which the values of all the dimensions are 0 is generated. Note that in a case where the value of the item of interest of the customer of interest is outside the assumed range, a case where a value outside the assumed range is input due to an input mistake or the like is assumed in addition to a case where the value of the item of interest is actually outside the assumed range.

Furthermore, for example, in a case where the item of interest is represented by continuous values, the learning data generation unit 41 may define an outlier (for example, a value that differs from an average by three times or more a standard deviation) on the basis of the average and the standard deviation of the item of interest of each customer, and may generate the one-of-k vector in which the values of all the dimensions are 0 in a case where the value of the item of interest of the customer of interest is the outlier.

Moreover, for example, in a case where the item of interest is represented by a categorical value, a value having an appearance frequency in the customer/contract database 21 less than a predetermined threshold value may be treated as a missing value.

Thereafter, the one-of-k vector generation processing ends.

Returning to FIG. 4, in Step S34, the learning data generation unit 41 determines whether or not the one-of-k vector has been generated for all the items. In a case where an item for which the one-of-k vector has not been generated still remains among the items that are the targets of the feature amount vector of the customer information of the customer of interest, the learning data generation unit 41 determines that the one-of-k vector has not been generated for all the items, and the processing returns to Step S32.

Thereafter, the processings of Steps S32 to S34 are repeatedly performed until it is determined in Step S34 that the one-of-k vector has been generated for all the items.

On the other hand, in Step S34, in a case where no item for which the one-of-k vector has not been generated remains among the items that are the targets of the feature amount vector of the customer information of the customer of interest, the learning data generation unit 41 determines that the one-of-k vector has been generated for all the items, and the processing proceeds to Step S35.

In Step S35, the learning data generation unit 41 connects the one-of-k vectors of the respective items to generate the feature amount vector. That is, the learning data generation unit 41 generates the feature amount vector of the customer of interest by connecting the one-of-k vectors of the respective items of the customer of interest in a predetermined order.

Note that it is not always necessary to use all the items of the customer information for generation of the feature amount vector, and items to be used for generation of the feature amount vector may be selected. For example, in the customer information of the customer to be learned, an item whose data loss rate is equal to or greater than a predetermined threshold value may be excluded from the items to be used for generation of the feature amount vector.

In Step S36, the learning data generation unit 41 generates the data sample. Specifically, the learning data generation unit 41 acquires data indicating whether or not the customer of interest has withdrawn from the customer/contract database 21. Then, the learning data generation unit 41 generates the data sample including the feature amount vector as the input data and including data indicating whether or not the customer of interest has withdrawn as the label.

In addition, the learning data generation unit 41 assigns, as time information, the contract renewal date or the withdrawal date of the customer of interest to the data sample. Therefore, the time information indicates the freshness of the data sample.

Note that it is assumed that the withdrawal date is set to the contract renewal date of the contract in a case where the customer of interest has not renewed the contract. For example, in a case where the contract renewal date of the customer of interest is May 1, 2019, and the target customer has not renewed the contract, May 1, 2019 is set as the withdrawal date.

Note that, hereinafter, the i-th data sample of the learning data is represented by (x^{l}ᵢ, y^{l}ᵢ). x^{l}ᵢ represents the feature amount vector, and y^{l}ᵢ represents the label. l is a superscript indicating that it is the feature amount vector or the label of the learning data. Furthermore, hereinafter, the number of dimensions of the feature amount vector is represented by d. Moreover, the label y^{l}ᵢ is set to 1 in a case where the customer has withdrawn from the service, and the label y^{l}ᵢ is set to 0 in a case where the customer has renewed the service without withdrawing from the service.

Furthermore, hereinafter, the j-th data sample of the prediction data is represented by x^{p}ⱼ. x^{p}ⱼ represents the feature amount vector and is a vector representing the same type of feature amount as the feature amount vector x^{l}ᵢ of the learning data. p is a superscript indicating that it is the feature amount vector of the learning data. Note that the data sample of the prediction data does not include the label because it has not yet been determined whether or not the customer who is the target of the prediction data has withdrawn from the service.

Note that, hereinafter, the data sample whose time information is within a predetermined period is referred to as a data sample in the period. For example, a data sample whose time information is within May of 2019, that is, a data sample of a customer whose contract renewal date or withdrawal date is within May of 2019 is referred to as a data sample of May of 2019.

In Step S37, the learning data generation unit 41 determines whether or not the data samples of all the target customers have been generated. For example, in a case where a customer whose data sample has not been generated yet remains among the renewal targets in the past one year, the learning data generation unit 41 determines that the data samples of all the target customers have not been generated yet, and the processing returns to Step S31.

Thereafter, the processings of Steps S31 to S37 are repeatedly performed until it is determined in Step S37 that the data samples of all the target customers have been generated.

On the other hand, in Step S37, for example, in a case where no customer whose data sample has not been generated remains among the renewal targets in the past one year, the learning data generation unit 41 determines that the data samples of all the target customers have been generated, and the learning data generation processing ends.

Returning to FIG. 3, in Step S2, the learning unit 32 sets a weight for the learning data. For example, the learning unit 32 sets a weight for each data sample included in the learning data on the basis of a relationship with the prediction data.

For example, the learning unit 32 sets the weight for each data sample on the basis of a difference between the time information which is an attribute of the data sample and the time information which is an attribute of the prediction data, that is, a temporal difference between the data sample and the prediction data. More specifically, for example, the learning unit 32 sets a larger weight for a data sample whose time information is closer to the time information of the prediction data, that is, a newer data sample.

In Step S3, the learning unit 32 trains the prediction model on the basis of the learning data and the weight.

A prediction model p is expressed by, for example, the following Expression (1).

p(yᵢ=1|xᵢ)=f(xᵢ;w) (1)

f is a function for calculating a withdrawal probability of a customer with a feature amount xᵢ. Various functions can be applied to f, and for example, a function using a neural network is applied. w represents a parameter of the prediction model. Hereinafter, the number of parameters w (the number of parameters) is represented by D.

Furthermore, in the training of the prediction model p, for example, a cross entropy loss is used as an error function, and the parameter w is calculated by executing a gradient method on the sum of the error functions related to all the data samples of the learning data. The sum of the error functions is expressed by, for example, the following Expression (2).

$$\begin{matrix}[ Math . 1 ] & \\ {\sum }_{i = 1}^{n} {a}_{i} ℓ ( {x}_{i} , {y}_{i} , w ) & ( 2 )\end{matrix}$$

aᵢ represents a weight for the i-th data pool of the prediction data, and is set in the processing of Step S2. l(xᵢ,yᵢ,w) represents an error function. n represents the total number of the data samples of the learning data.

Here, for example, it is assumed that the feature of the data sample, that is, a tendency of the feature amount vector of each customer greatly differs between the learning period and the prediction period. For example, it is assumed that the feature of the data sample of the prediction data is greatly different from the feature of the data sample of the learning data in a case where a significant change in service content, the appearance or disappearance of a strong competitor, a significant change in customer base, or the like has occurred immediately before or during the contract period of the customer who is the target of the prediction data.

On the other hand, as described above, the larger weight aᵢ is set for the data sample of the learning data that is temporally closer to the prediction data, such that the prediction accuracy of the prediction model is improved.

In Step S4, the information processing system 11 updates the prediction model. For example, the learning unit 32 supplies the parameter w of the prediction model p calculated in the processing of Step S3 to the prediction unit 23. The prediction unit 23 updates the parameter w of the prediction model p.

Thereafter, the learning processing ends.

<First Embodiment of Prediction Processing>

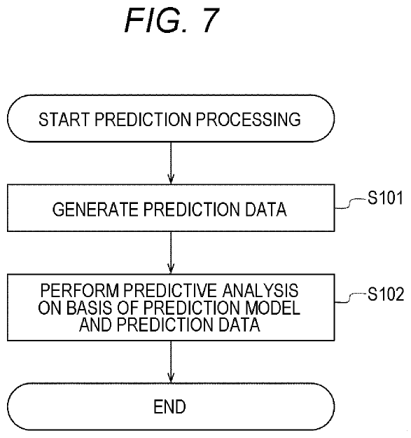

Next, prediction processing performed by the information processing system 11 corresponding to the learning processing of FIG. 3 will be described with reference to a flowchart of FIG. 7.

In Step S101, the information processing system 11 generates the prediction data. Specifically, the prediction data generation unit 42 generates the feature amount vector of each customer who is the target of the prediction data by performing processing similar to Step S1 of FIG. 3. Further, the prediction data generation unit 42 generates the data sample including the feature amount vector of each customer as the input data for each customer, and assigns the contract renewal date of each customer to each data sample as the time information. Then, the prediction data generation unit 42 generates the prediction data including the data sample of each customer and supplies the prediction data to the prediction unit 23.

In Step S102, the prediction unit 23 performs the predictive analysis on the basis of the prediction model and the prediction data. That is, the prediction unit 23 calculates the withdrawal probability of each customer by applying the data sample of each customer included in the prediction data to the prediction model.

Thereafter, the prediction processing ends.

As described above, the weight for each data sample of the learning data can be appropriately set on the basis of the relationship with the prediction data, such that the prediction accuracy of the prediction model is improved.

In addition, conventionally, a technique called covariate shift is known as a technique of additionally using the prediction data at the time of training the prediction model. In the covariate shift, each data sample of the learning data is weighted on the basis of probability distribution for generating the feature amount vector of the learning data and probability distribution for generating the feature amount vector of the prediction data to perform learning. However, it is difficult to perform estimation, because a calculation amount necessary for estimation of the probability distribution is large. In addition, there is learning data that is not suitable for the estimation of the probability distribution.

On the other hand, the present technology only sets the weight for each data sample of the learning data on the basis of the relationship with the prediction data, and thus the calculation amount is small. In addition, the present technology can be applied regardless of the type of the learning data.

### 2. Second Embodiment

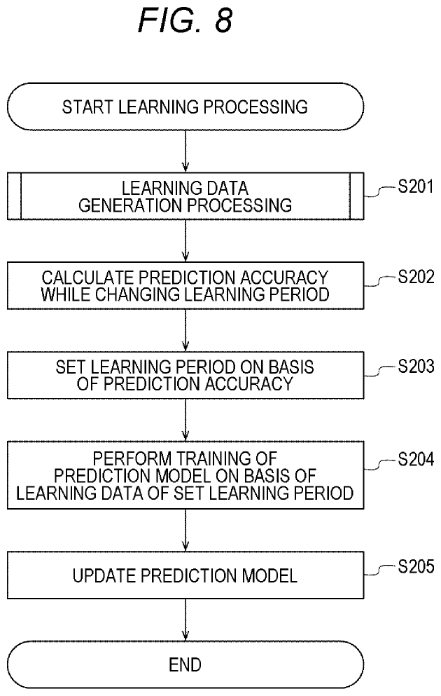

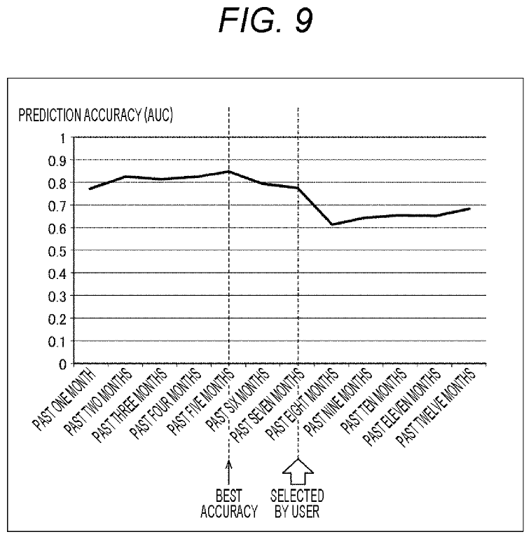

Next, a second embodiment of the present technology will be described with reference to FIGS. 8 and 9.

Note that the second embodiment is different from the first embodiment in regard to learning processing. Specifically, a period for which learning data is to be generated is adjusted.

<Second Embodiment of Learning Processing>

A second embodiment of the learning processing performed by an information processing system 11 will be described with reference to a flowchart of FIG. 8.

Note that, similarly to the first embodiment, a case where a withdrawal probability of a renewal target of May of 2019 is predicted will be described below as an example.

In Step S201, learning data generation processing is performed similarly to the processing of Step S1 of FIG. 2. Note that, in this processing, for example, learning data is generated for the renewal target within the past 13 months. For example, the learning data is generated on the basis of customer information in a contract period of the renewal target from Apr. 1, 2018 to Apr. 30, 2019.

In Step S202, a learning unit 32 calculates prediction accuracy while changing a learning period.

For example, the learning unit 32 generates partial data obtained by extracting a data sample of the renewal target in March of 2019 from the learning data. Then, the learning unit 32 trains a prediction model by using the generated partial data. As a result, the prediction model whose learning period is March of 2019 is generated.

Next, the learning unit 32 generates partial data obtained by extracting a data sample of the renewal target in a period from February of 2019 to March of 2019 from the learning data. Then, the learning unit 32 trains a prediction model by using the generated partial data. As a result, a prediction model whose learning period is from February of 2019 to March of 2019 is generated.

Next, the learning unit 32 generates partial data obtained by extracting a data sample of the renewal target in a period from January of 2019 to March of 2019 from the learning data. Then, the learning unit 32 trains a prediction model by using the generated partial data. As a result, a prediction model whose learning period is from January of 2019 to March of 2019 is generated.

Hereinafter, similarly, the learning unit 32 trains the prediction model by using each piece of partial data while expanding a range of the partial data by one month up to April of 2018. As a result, 12 prediction models in the past N months (N is a natural number from 1 to 12) having different learning periods based on April of 2019 are generated.

Next, the learning unit 32 extracts a data sample of the renewal target in April of 2019 from the learning data and deletes a label from the data sample of each renewal target, thereby generating virtual prediction data. The virtual prediction data is temporally closer to the actual prediction data than the other partial data. That is, the virtual prediction data is generated from a part of the learning data and includes a data sample in a period closer to the actual prediction data than the other partial data.

Next, the learning unit 32 predicts a withdrawal probability of each renewal target in April of 2019 by applying the virtual prediction data to each prediction model.

Then, the learning unit 32 calculates the prediction accuracy of each prediction model on the basis of the predicted value of the withdrawal probability of each renewal target in April of 2019 and whether or not each renewal target has actually withdrawn. For example, the Are Under the Curve (AUC) or the like is used to calculate the prediction accuracy.

In Step S203, the learning unit 32 sets the learning period on the basis of the prediction accuracy. For example, the learning unit 32 sets a period of partial data used for training of a prediction model having the highest prediction accuracy as a target period (learning period) of learning data used for training of the prediction model.

FIG. 9 is a graph illustrating an example of a result of calculating the prediction accuracy of the prediction model. In FIG. 9, a horizontal axis represents the period (learning period) of the partial data used to generate the prediction model, and a vertical axis represents the prediction accuracy.

In this example, the prediction accuracy of the prediction model trained using the partial data of a period from five months ago to one month ago (past five months) is the highest. Therefore, for example, the learning period is set to five months. That is, the period from five months ago to one month ago from a target prediction month is set as the target period for the learning data used for the training of the prediction model.

Note that, for example, an UI unit 24 may present a graph of FIG. 9 to the user and cause the user to set the learning period. FIG. 9 illustrates an example in which the learning period is set to seven months by the user.

In Step S204, the learning unit 32 trains the prediction model on the basis of the learning data of the set learning period. For example, in a case where the learning period is set to five months, the learning unit 32 extracts, from the learning data, a data sample of the renewal target in a period from December of 2018 to April of 2019, which is 5 months before May of 2019 as the target prediction month, to generate partial data. Then, the learning unit 32 trains the prediction model by using the generated partial data.

In Step S205, the prediction model is updated similarly to the processing of Step S4 of FIG. 3.

Thereafter, the learning processing ends.

As described above, the learning period is appropriately set, and as a consequence, the prediction accuracy of the prediction model is improved.

Note that, for example, after the learning period is once set, the learning period may be fixed without performing the processings of Step S202 and Step S203 described above. As a result, a computation amount and time required for training the prediction model can be reduced. In addition, by setting the learning period to be shorter than one year, a data amount of the learning data is reduced, and a learning time is shortened.

Note that, in a case where the learning period is fixed, for example, the learning unit 32 may periodically perform the processings of Step S202 and Step S203 to update the learning period.

### 3. Third Embodiment

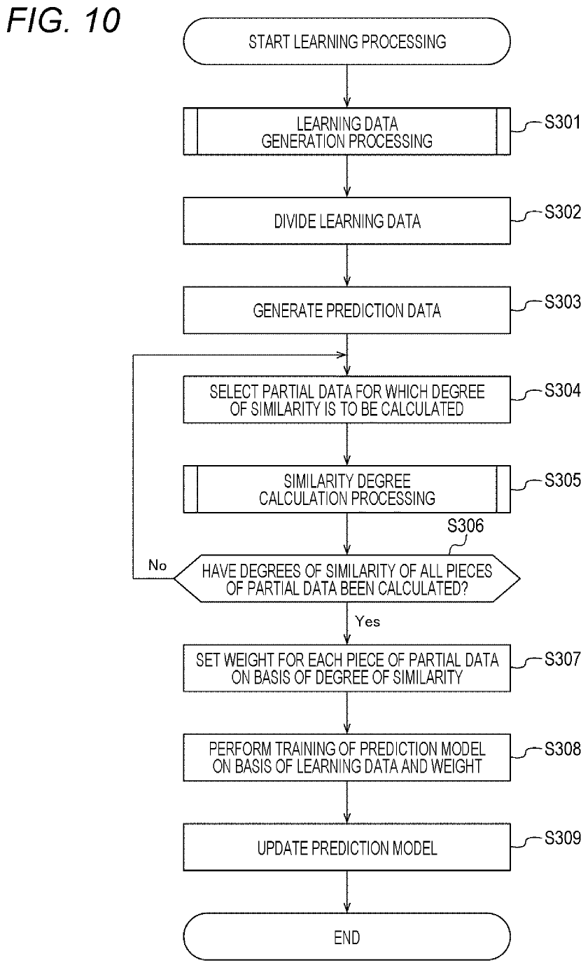

Next, a third embodiment of the present technology will be described with reference to FIGS. 10 to 12.

Note that the third embodiment is different from the above-described embodiments in regard to learning processing. Specifically, a weight for learning data is set on the basis of a degree of similarity between the learning data and prediction data to perform the learning processing.

<Third Embodiment of Learning Processing>

A third embodiment of the learning processing performed by an information processing system 11 will be described with reference to a flowchart of FIG. 10.

Note that, similarly to the first embodiment, a case where a withdrawal probability of a renewal target of May of 2019 is predicted will be described below as an example.

In Step S301, learning data generation processing is performed similarly to the processing of Step S1 of FIG. 2. That is, the learning data is generated on the basis of customer information in a contract period of the renewal target from May of 2018 to April of 2019.

In Step S302, the learning data generation unit 41 divides the learning data. For example, the learning unit 32 divides the learning data for each renewal target in each month from May of 2018 to April of 2019, thereby generating 12 pieces of partial data each including a data sample of the renewal target in different periods (each month).

In Step S303, the prediction data is generated similarly to the processing of Step S101 of FIG. 7. That is, the prediction data is generated on the basis of the customer information in the contract period of the renewal target in May of 2019.

In Step S304, the learning unit 32 selects partial data for which the degree of similarity is to be calculated. That is, the learning unit 32 selects one piece of partial data for which the degree of similarity has not yet been calculated.

In Step S305, the learning unit 32 performs similarity degree calculation processing.

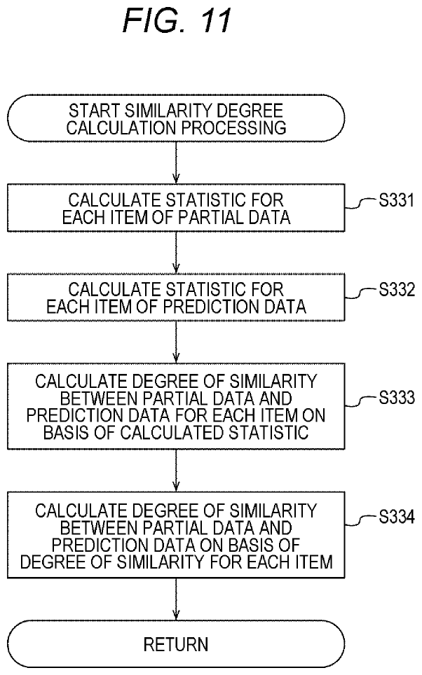

Here, details of the similarity degree calculation processing will be described with reference to a flowchart of FIG. 11.

In Step S331, the learning unit 32 calculates a statistic for each item of the partial data. Specifically, the learning unit 32 calculates a statistic of a feature amount of each item represented by a feature amount vector of each data sample included in the partial data.

Note that a method of calculating the statistic of the feature amount of each item is not particularly limited. For example, in a case where a feature amount of a certain item is represented by continuous values, three types of values, an average, a standard deviation, and a median, are calculated after normalization is performed between the respective data samples, and a three-dimensional vector having these values as elements is calculated as a statistic for the item. Furthermore, for example, in a case where a feature amount of a certain item is represented by a categorical value, a k-dimensional vector having an appearance rate of each of k types of possible values as an element is calculated as a statistic for the item.

In Step S332, the learning unit 32 calculates a statistic for each item of the prediction data. Specifically, the learning unit 32 calculates the statistic of the feature amount of each item represented by the feature amount vector of each data sample included in the prediction data by a method similar to Step S331.

In Step S333, the learning unit 32 calculates the degree of similarity between the partial data and the prediction data for each item on the basis of the calculated statistic.

Note that a method of calculating the degree of similarity of each item is not particularly limited. For example, in a case where a statistic of a certain item is represented by a vector, the learning unit 32 calculates an inner product of a vector of the partial data and a vector of the prediction data as a degree of similarity of the item.

In Step S334, the learning unit 32 calculates the degree of similarity between the partial data and the prediction data on the basis of the degree of similarity for each item. For example, the learning unit 32 calculates the degree of similarity between the partial data and the prediction data by adding the degree of similarity for each item.

Thereafter, the similarity degree calculation processing ends.

Returning to FIG. 10, in Step S306, the learning unit 32 determines whether or not the degrees of similarity of all pieces of the partial data have been calculated. In a case where there remains partial data for which the degree of similarity has not been calculated, the learning unit 32 determines that the degree of similarity has not been calculated for all pieces of the partial data, and the processing returns to Step S304.

Thereafter, the processings of Steps S304 to S306 are repeatedly performed until it is determined in Step S306 that the degrees of similarity of all pieces of the partial data have been calculated.

On the other hand, in a case where it is determined in Step S306 that the degrees of similarity of all pieces of the partial data have been calculated, the processing proceeds to Step S307.

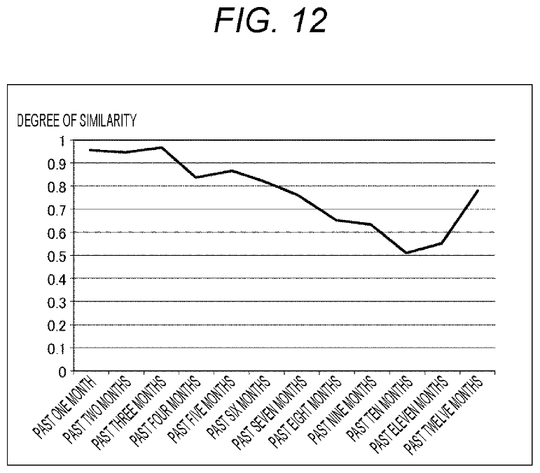

FIG. 12 is a graph illustrating an example of a result of calculating the degree of similarity between each piece of partial data and the prediction data. A horizontal axis represents a target period for the partial data, and a vertical axis represents the degree of similarity. That is, FIG. 12 illustrates a degree of similarity between partial data for a renewal target in the past one month and the prediction data, a degree of similarity between partial data for a renewal target in the past two months and the prediction data, . . . , and a degree of similarity between partial data for a renewal target in the past 12 months and the prediction data.

In Step S307, the learning unit 32 sets a weight for each piece of partial data on the basis of the degree of similarity. For example, the learning unit 32 sets a larger weight for a data sample included in partial data having a higher degree of similarity to the prediction data, and sets a smaller weight for a data sample included in partial data having a lower degree of similarity to the prediction data.

In Step S308, a prediction model is trained on the basis of the learning data and the weight by performing processing similar to Step S3 of FIG. 3.

In Step S309, the prediction model is updated by performing processing similar to that of Step S4 of FIG. 3.

Thereafter, the learning processing ends.

As described above, the prediction model is trained by additionally using the degree of similarity between each piece of partial data and the prediction data, such that the prediction accuracy of the prediction model can be improved. For example, in a case where a behavior of the customer periodically changes depending on the season or the like, the prediction accuracy of the prediction model can be improved. For example, in a case where a behavior of a customer in a specific month (for example, December) is greatly different from that in other months, when the predictive analysis is performed for the month, the prediction accuracy can be improved by setting a larger weight for partial data of the same month of the past one year.

Note that, although the learning data is divided in units of one month in the above example, but a unit in which the learning data is divided may be adjusted. For example, the learning unit 32 may calculate the prediction accuracy for each division unit while changing the unit in which the learning data is divided (for example, one week, one month, two months, and the like) by a method similar to the learning processing of FIG. 8, and set the division unit on the basis of the prediction accuracy.

Furthermore, in the present embodiment, the prediction data is generated in the learning processing. Therefore, it is possible to omit the processing of generating the prediction data in the prediction processing by using the prediction data generated by the learning processing.

### 4. Fourth Embodiment

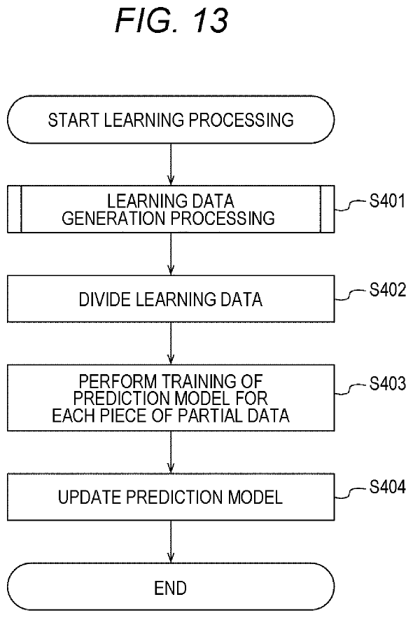

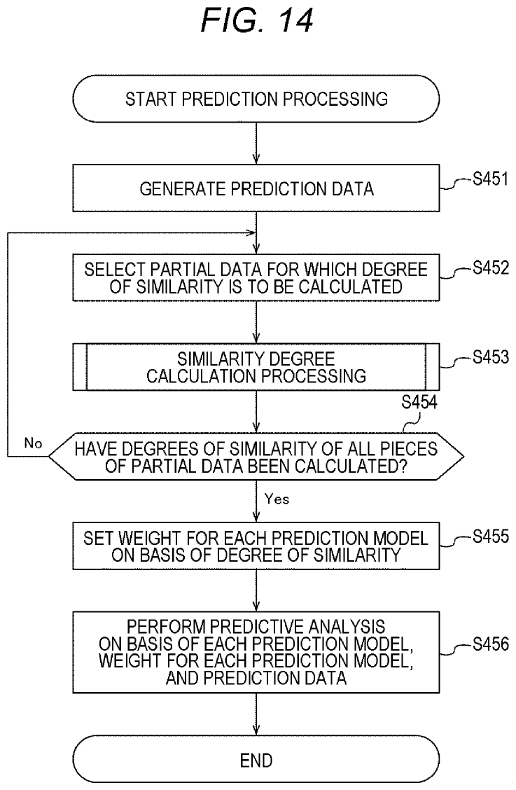

Next, a fourth embodiment of the present technology will be described with reference to FIGS. 13 and 14.

Note that the fourth embodiment is different from the above-described embodiments in regard to learning processing and prediction processing. Specifically, learning data is divided into a plurality of pieces of partial data, a prediction model is generated for each piece of partial data, and predictive analysis is performed using a plurality of prediction models.

<Fourth Embodiment of Learning Processing>

First, a fourth embodiment of the learning processing performed by an information processing system 11 will be described with reference to a flowchart of FIG. 13.

Note that, similarly to the first embodiment, a case where a withdrawal probability of a renewal target of May of 2019 is predicted will be described below as an example.

In Step S401, learning data generation processing is performed similarly to the processing of Step S1 of FIG. 2. That is, the learning data is generated on the basis of customer information in a contract period of the renewal target from May of 2018 to April of 2019.

In Step S402, the learning data is divided similarly to the processing of Step S302 of FIG. 10. As a result, for example, the learning data is divided for each renewal target in each month from May of 2018 to April of 2019, and 12 pieces of partial data each including a data sample of the renewal target in each month are generated.

In Step S403, the learning unit 32 trains the prediction model for each piece of partial data. As a result, 12 prediction models having different learning periods are generated on the basis of the partial data of each month from May of 2018 to April of 2019.

Note that, hereinafter, a prediction model generated on the basis of partial data of a certain month is referred to as a prediction model of the month. For example, a prediction model generated on the basis of partial data of April of 2019 is referred to as a prediction model of April of 2019.

In Step S404, the information processing system 11 updates the prediction model. Specifically, the learning unit 32 supplies a parameter of each prediction model calculated in the processing of Step S403 to a prediction unit 23. The prediction unit 23 updates the parameter of each prediction model.

Thereafter, the learning processing ends.

Note that, for example, in a case where the learning processing is periodically performed every month, the prediction models up to March of 2019, which is one month ago, have already been generated. Therefore, for example, it is also possible to generate only the learning data of April of 2019 and generate the prediction model of April of 2019 on the basis of the learning data of April of 2019. As a result, a load of the learning processing can be reduced.

<Second Embodiment of Prediction Processing>

Next, the prediction processing performed by the information processing system 11 corresponding to the learning processing of FIG. 13 will be described with reference to FIG. 14.

In Step S451, prediction data is generated similarly to the processing of Step S101 of FIG. 7. That is, the prediction data is generated on the basis of the customer information in the contract period of the renewal target in May of 2019.

In Step S452, similarly to the processing of Step S304 of FIG. 10, partial data for which the degree of similarity is to be calculated is selected.

In Step S453, similarity degree calculation processing is performed similarly to the processing of Step S305 of FIG. 10. As a result, the degree of similarity between the selected partial data and the prediction data is calculated.

In Step S454, similarly to the processing of Step S306 of FIG. 10, it is determined whether or not the degrees of similarity of all pieces of the partial data have been calculated. In a case where it is determined that the degree of similarity of all pieces of the partial data has not been calculated yet, the processing returns to Step S452.

Thereafter, the processings of Steps S452 to S454 are repeatedly performed until it is determined in Step S454 that the degrees of similarity of all pieces of the partial data have been calculated.

On the other hand, in a case where it is determined in Step S454 that the degrees of similarity of all pieces of the partial data have been calculated, the processing proceeds to Step S455.

In Step S455, the prediction unit 23 sets a weight for each prediction model on the basis of the degree of similarity. Specifically, the prediction unit 23 sets a larger weight for a prediction model trained with learning data corresponding to the prediction model, that is learning data having a higher degree of similarity to the prediction data. On the other hand, the prediction unit 23 sets a smaller weight for a prediction model corresponding to learning data having a lower degree of similarity to the prediction data.

In Step S456, the prediction unit 23 performs the predictive analysis on the basis of each prediction model, the weight for each prediction model, and the prediction data. Specifically, the prediction unit 23 predicts a withdrawal probability of each renewal target in a target prediction month for each prediction model by applying the prediction data to each prediction model. As a result, for each renewal target, a plurality of withdrawal probabilities is predicted for each prediction model.

Next, the prediction unit 23 calculates a weighted average of the withdrawal probabilities for each prediction model of each renewal target by using the weight for each prediction model, thereby calculating the final withdrawal probability of each renewal target.

Thereafter, the prediction processing ends.

As described above, the prediction model is generated on the basis of each piece of partial data, and a prediction result of each prediction model is combined in consideration of the degree of similarity between each piece of partial data and the prediction data, whereby the prediction accuracy can be improved. For example, similarly to the third embodiment, in a case where a behavior of the customer periodically changes depending on the season or the like, the prediction accuracy can be improved.

### 5. Fifth Embodiment

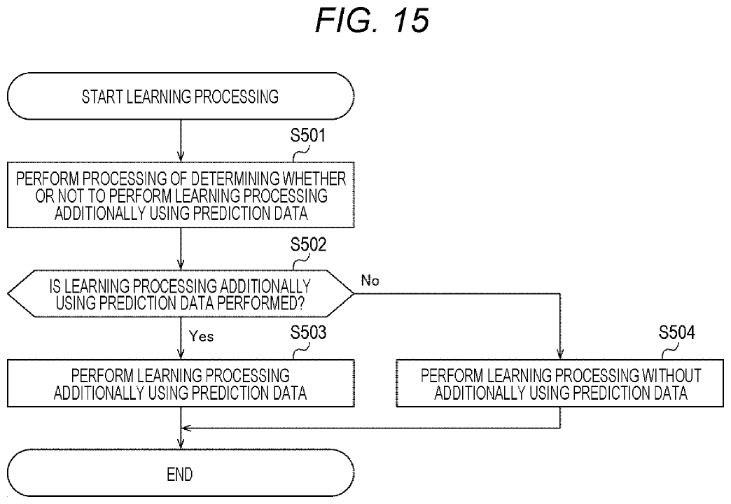

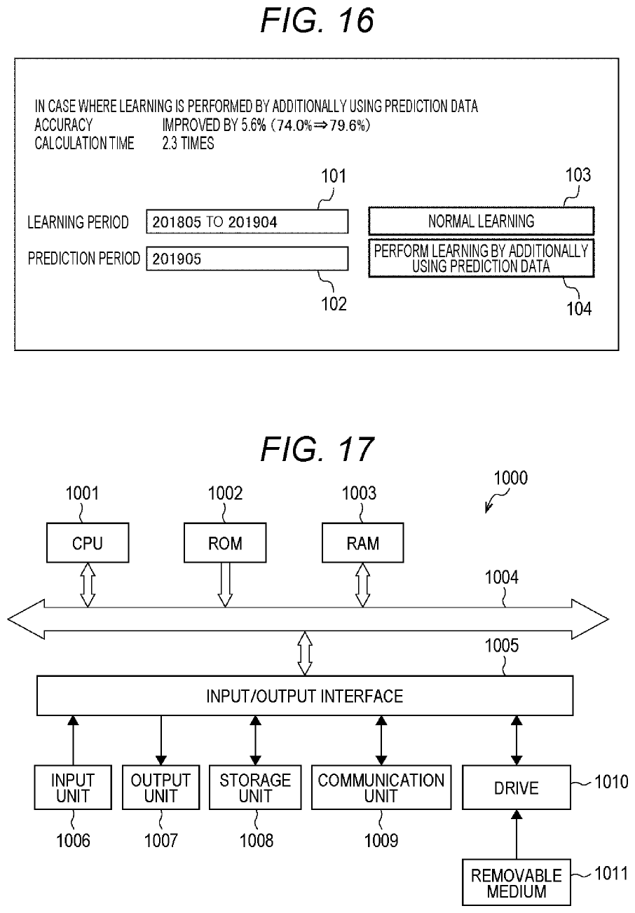

Next, a fifth embodiment of the present technology will be described with reference to FIGS. 15 and 16.

Note that, in the fifth embodiment, learning processing is performed by selecting whether or not to perform the learning processing by additionally using prediction data.

<Fifth Embodiment of Learning Processing>

A fifth embodiment of the learning processing performed by an information processing system 11 will be described with reference to a flowchart of FIG. 15.

Note that, similarly to the first embodiment, a case where a withdrawal probability of a renewal target of May of 2019 is predicted will be described below as an example.

In Step S501, the learning unit 32 performs processing of determining whether or not to perform the learning processing by additionally using the prediction data.

In Step S502, the learning unit 32 determines whether or not to perform the learning processing by additionally using the prediction data on the basis of a result of the processing of Step S501. In a case where it is determined that the learning processing additionally using the prediction data is to be performed, the processing proceeds to Step S503.

In Step S503, the learning unit 32 performs the learning processing by additionally using the prediction data. In other words, the learning unit 32 trains a prediction model by a learning method based on learning data and the prediction data.

Thereafter, the learning processing ends.

On the other hand, in a case where it is determined in Step S502 that the learning processing additionally using the prediction data is not performed, the processing proceeds to Step S504.

In Step S504, the learning unit 32 performs the learning processing without additionally using the prediction data. In other words, the learning unit 32 trains the prediction model by a learning method based (only) on the learning data without using the prediction data.

Thereafter, the learning processing ends.

Here, a specific example of this learning processing will be described.

For example, the learning unit 32 determines whether or not to perform the learning processing by additionally using the prediction data on the basis of a degree of similarity between the learning data and the prediction data.

For example, the learning unit 32 randomly extracts, from the learning data, the same number of data samples as the number of data samples in the prediction data. Then, the learning unit 32 calculates the degree of similarity between the learning data including the extracted data sample and the prediction data.

Note that a method of calculating the degree of similarity is not particularly limited, but for example, the method described above with reference to FIG. 11 can be applied.

Then, for example, in a case where the degree of similarity between the learning data and the prediction data is less than a predetermined threshold value, a feature of the learning data and a feature of the prediction data are greatly different from each other, and thus, the learning processing is performed by additionally using the prediction data. For example, the learning processing in FIG. 3, FIG. 8, FIG. 10, or FIG. 13 is performed. As a result, the prediction accuracy of the prediction model is improved.

On the other hand, in a case where the degree of similarity between the learning data and the prediction data is equal to or greater than the predetermined threshold value, the feature of the learning data and the feature of the prediction data are not much different from each other. Therefore, the learning processing is performed without additionally using the prediction data. As a result, a load of the learning processing is reduced, and a learning time is shortened.

Furthermore, for example, the learning unit 32 classifies the learning data into a plurality of pieces of partial data of different periods, and determines whether or not to perform the learning processing by additionally using the prediction data on the basis of the degree of similarity between the pieces of partial data.

For example, the learning unit 32 divides the learning data in units of months and generates partial data for each month. Then, the learning unit 32 calculates, for example, the degree of similarity between the respective pieces of partial data.

Note that a method of calculating the degree of similarity is not particularly limited, but for example, the method described above with reference to FIG. 11 can be applied.

Then, for example, in a case where an average of differences in degree of similarity between the pieces of partial data is equal to or greater than a predetermined threshold value, a variation between the pieces of partial data is large, and there is a high possibility that the feature of the learning data and the feature of the prediction data are greatly different. Therefore, the learning processing is performed by additionally using the prediction data. For example, the learning processing in FIG. 3, FIG. 8, FIG. 10, or FIG. 13 is performed. As a result, the prediction accuracy of the prediction model is improved.

On the other hand, in a case where the average of the differences in degree of similarity between the pieces of partial data is less than the predetermined threshold value, the variation between the pieces of partial data is small, and there is a low possibility that the feature of the learning data and the feature of the prediction data are greatly different. Therefore, the learning processing is performed without additionally using the prediction data. As a result, a load of the learning processing is reduced, and a learning time is shortened.

Alternatively, for example, the learning unit 32 selects a learning method on the basis of a time-series change in degree of similarity between the pieces of partial data.

For example, the learning unit 32 calculates the degree of similarity between partial data of the oldest month and partial data of each of other months. Then, in a case where the degree of similarity decreases by a predetermined threshold value or more as a time interval between the pieces of partial data increases, the time-series change of the learning data is large, and there is a high possibility that the feature of the learning data and the feature of the prediction data are greatly different. Therefore, the learning processing is performed by additionally using the prediction data. For example, the learning processing in FIG. 3, FIG. 8, FIG. 10, or FIG. 13 is performed. As a result, the prediction accuracy of the prediction model is improved.

On the other hand, in a case where the degree of similarity decreases by less than the predetermined threshold value even when the time interval between the pieces of partial data increases, the time-series change of the learning data is small, and there is a low possibility that the feature of the learning data and the feature of the prediction data are greatly different. Therefore, the learning processing is performed without additionally using the prediction data. As a result, a load of the learning processing is reduced, and a learning time is shortened.

Moreover, for example, the learning unit 32 estimates the prediction accuracy in a case where the prediction data is considered and the prediction accuracy in a case where the prediction data is not considered, and determines whether or not to perform the learning processing additionally using the prediction data on the basis of the estimated prediction accuracies.

For example, the learning unit 32 performs the learning processing by additionally using the prediction data on the basis of the learning data and virtual prediction data by a method similar to the method described above with reference to FIG. 8, and calculates the prediction accuracy of the generated prediction model. In addition, the learning unit 32 performs the learning processing only on the basis of the learning data without additionally using the prediction data, and calculates the prediction accuracy of the generated prediction model. Moreover, the learning unit 32 calculates a difference between the prediction accuracy in a case where the prediction data is considered and the prediction accuracy in a case where the prediction data is not considered as an estimated value of an improvement rate of the prediction accuracy.

Then, for example, in a case where the estimated value of the improvement rate of the prediction accuracy is equal to or more than a predetermined threshold value, the learning unit 32 performs the learning processing by additionally using the prediction data. As a result, the prediction accuracy of the prediction model is improved. On the other hand, for example, in a case where the estimated value of the improvement rate of the prediction accuracy is less than the predetermined threshold value, the learning unit 32 performs the learning processing without additionally using the prediction data. As a result, a load of the learning processing is reduced, and a learning time is shortened.

Note that, in addition to the prediction accuracy of the prediction model, a learning time (a time required for training the prediction model) may be considered when determining whether or not to perform the learning processing by additionally using the prediction data.

For example, the learning unit 32 calculates a value obtained by dividing a time required for the learning processing in a case where the prediction data is considered by a time required for the learning processing in a case where the prediction data is not considered as an estimated value of an increase rate of the learning time. The increase rate of the learning time represents a difference between the time required for the learning processing in a case where the prediction data is considered and the time required for the learning processing in a case where the prediction data is not considered.

Then, for example, in a case where the estimated value of the degree of improvement in prediction accuracy is equal to or greater than the predetermined threshold value and the estimated value of the increase rate of the learning time is less than the predetermined threshold value, the learning unit 32 performs the learning processing by additionally using the prediction data. As a result, the prediction accuracy of the prediction model is improved while an increase of the learning time is suppressed. On the other hand, for example, in a case where the estimated value of the degree of improvement in prediction accuracy is less than the predetermined threshold value or the estimated value of the increase rate of the learning time is equal to or greater than the predetermined threshold value, the learning unit 32 performs the learning processing without additionally using the prediction data. As a result, a load of the learning processing is reduced, and a learning time is shortened.

Note that, for example, an UI unit 24 may present a setting screen of FIG. 16 to allow the user to select whether or not to perform learning by additionally using the prediction data.

On the setting screen of FIG. 16, an estimated value (79.6%) of the prediction accuracy in a case where the prediction data is considered, an estimated value (74.0%) of the prediction accuracy in a case where the prediction data is not considered, and an estimated value (5.6%) of the improvement rate of the prediction accuracy are displayed. In addition, the increase rate (2.3 times) of the learning time (a calculation time in FIG. 16) is displayed.

In addition, a learning period input field 101 and a prediction period input field 102 are displayed.

Moreover, an execution button 103 for performing normal learning and an execution button 104 for performing learning by additionally using the prediction data are displayed.

As a result, for example, the user can select and execute a learning method suitable for the user's needs in consideration of the improvement rate of the prediction accuracy and the increase rate of the learning time.

### 6. Modified Examples

Hereinafter, modified examples of the above-described embodiments of the present technology will be described.

### Modified Example of First Embodiment

For example, the weight of each data sample of the learning data may be set using another attribute in addition to or instead of the time information.

Specifically, for example, in a case where each data sample of the learning data and the prediction data has spatial information (for example, customer's location, data acquisition location, and the like), the weight of each data sample may be set on the basis of a difference between the spatial information of each data sample of the learning data and the spatial information of the prediction data. For example, a larger weight may be set for a data sample spatially closer to the prediction data, and a smaller weight may be set for a data sample spatially farther from the prediction data.

### Modified Example of Second Embodiment

For example, the prediction accuracy of each learning period may be calculated while changing the learning periods so as not to overlap each other.

Furthermore, for example, the prediction accuracy may be calculated while changing the range of the learning data by using another attribute in addition to or instead of the time information to set a range of the learning data used for training of the prediction model.

Specifically, for example, in a case where each data sample of the learning data has the spatial information, the prediction accuracy may be calculated while changing a spatial range of the learning data to set a spatial range (for example, a region of the customer, a region where the data is acquired, and the like) of the learning data used for training of the prediction model. In this case, for example, as the virtual prediction data, data spatially closer to the actual prediction data than other partial data in the learning data is used.

### Modified Example of Third Embodiment

For example, the learning data may be divided into a plurality of ranges by using another attribute in addition to or instead of the time information, and the degree of similarity between each piece of partial data and the prediction data may be calculated.

Specifically, for example, in a case where each data sample of the learning data has the spatial information, the partial data may be generated by spatially dividing the learning data into a plurality of ranges. Furthermore, for example, the learning data may be divided by a predetermined clustering method.

### Modified Example of Fourth Embodiment

For example, the learning data may be divided into a plurality of ranges by using another attribute in addition to or instead of the time information, and a plurality of prediction models may be generated using each piece of learning data.

For example, in a case where each data sample of the learning data has the spatial information, the partial data may be generated by spatially dividing the learning data into a plurality of ranges. Furthermore, for example, the learning data may be divided into a plurality of ranges by a predetermined clustering method.

### Modified Example of Fifth Embodiment

For example, the learning data may be divided into a plurality of ranges by using another attribute in addition to or instead of the time information, and whether or not to perform the learning processing additionally using the prediction data may be determined on the basis of the degree of similarity between the respective pieces of partial data.

Specifically, for example, in a case where each data sample of the learning data has the spatial information, the learning data may be spatially divided into a plurality of ranges, and whether or not to perform the learning processing additionally using the prediction data may be determined on the basis of the degree of similarity between the respective pieces of partial data.

<Modified Example Related to Learning Data Generation Method>

For example, the learning data may be generated on the basis of the prediction data.

Specifically, for example, the feature amount vector of the learning data may be generated on the basis of the prediction data. More specifically, for example, the feature amount used for generating the feature amount vector may be set in consideration of the prediction data.

For example, in some cases, an item that rarely differs between customers in the customer information in the learning period is not used for the feature amount vector because the feature of the customer does not appear remarkably. However, in a case where the difference of the item between the customers in the customer information in the prediction period exceeds a predetermined threshold value, the item may be used for generating the feature amount vector. That is, the feature amount vector may include the feature amount represented by the item. Here, for example, a case where the tendency or behavior of the customer greatly changes or the like is assumed.

Conversely, for example, in a case of an item that excessively differs between customers in the customer information in the learning period, for example, an item represented by a categorical value, an item in which the number of types (unique number) of values set for the number of customers (the number of data) is excessively large is not used as the feature amount vector in some cases. However, in a case where a ratio of the unique number to the number of data is less than a predetermined threshold value in the item in the customer information in the prediction period, the item may be used for generating the feature amount vector. That is, the feature amount vector may include the feature amount represented by the item.

Furthermore, for example, an item having a high data loss rate in the customer information in the learning period is not used for the feature amount vector in some cases. However, in the customer information in the prediction period, in a case where the loss rate in the customer information of the item is less than a predetermined threshold value, the item may be used for generating the feature amount vector. That is, the feature amount vector may include the feature amount represented by the item. Here, for example, a case where an item whose information is collected from a customer is newly added or the like is assumed.

Moreover, for example, various statistics (for example, an average, a variance, a minimum value, a maximum value, an appearance frequency, a loss rate, and the like) may be calculated using not only the learning data but also the prediction data, and the feature vector may be generated using the calculated statistics. In this case, the statistic may be calculated using different weights for the learning data and the prediction data.

Furthermore, for example, a peculiar data sample in the learning data may be specified on the basis of the statistic calculated using the learning data and the prediction data.

### Other Modified Examples

In a case where the learning data is divided into pieces of partial data in different ranges (for example, periods, regions, or the like), the ranges of the respective pieces of partial data do not have to overlap each other or may partially overlap each other. In the latter case, one data sample may be included in a plurality of pieces of partial data. In other words, the plurality of pieces of partial data may include the same data sample.

Furthermore, the configuration of the information processing system 11 of FIG. 1 is an example and can be changed.

For example, the data generation unit 31 can be provided separately from the learning processing unit 22, or the prediction data generation unit 42 can be provided in the prediction unit 23.

Moreover, for example, the information processing system 11 can be implemented by one information processing device or can be implemented by a plurality of information processing devices.

Furthermore, for example, the prediction accuracy of the prediction model using a plurality of different learning methods (for example, the learning methods according to the first to fourth embodiments) may be calculated using a part of the learning data as the virtual prediction data, and the learning method for the prediction model may be selected on the basis of a result of the calculation.

Moreover, the present technology can be applied not only to a case of performing the predictive analysis related to the service described above but also to a case of performing various types of predictive analyses. That is, the present technology can be applied to a case where training of the prediction model is performed using the learning data, and various types of predictive analyses are performed using the prediction model and the prediction data.

### 7. Others

<Example of Configuration of Computer>

The series of processings described above can be performed by hardware or can be performed by software. In a case where the series of processings is performed by software, a program constituting the software is installed in a computer. Here, the computer includes a computer incorporated in dedicated hardware, a general-purpose personal computer capable of executing various functions by installing various programs, and the like, for example.

FIG. 17 is a block diagram illustrating an example of a configuration of hardware of a computer performing the series of processings described above by using a program.

In a computer 1000, a central processing unit (CPU) 1001, a read only memory (ROM) 1002, and a random access memory (RAM) 1003 are connected to one another by a bus 1004.

Moreover, an input/output interface 1005 is connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The recording unit 1008 includes a hard disk, a nonvolatile memory, and the like. The communication unit 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads, for example, a program stored in the recording unit 1008 to the RAM 1003 through the input/output interface 1005 and the bus 1004, and executes the program, such that the series of processings described above is performed.

The program executed by the computer 1000 (CPU 1001) can be provided by being recorded in the removable recording medium 1011 as a package medium or the like, for example. Furthermore, the program can be provided via a wired or wireless transmission medium such as a local area network, the Internet, or digital satellite broadcasting.

In the computer 1000, the program can be installed in the recording unit 1008 via the input/output interface 1005 by mounting the removable recording medium 1011 on the drive 1010. Furthermore, the program can be received by the communication unit 1009 via a wired or wireless transmission medium and installed in the recording unit 1008. In addition, the program can be installed in the ROM 1002 or the recording unit 1008 in advance.

Note that the program executed by the computer may be a program by which the processing is performed in time series in the order described in the present specification, or may be a program by which the processings are performed in parallel or at a necessary timing such as when a call is performed or the like.

In addition, in the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Moreover, the embodiment of the present technology is not limited to those described above, and may be variously changed without departing from the gist of the present technology.

For example, the present technology can have a configuration of cloud computing in which one function is performed by a plurality of devices in cooperation via a network.

Furthermore, each step described in the above-described flowchart can be performed by one device or can be performed by a plurality of devices in a distributed manner.

Moreover, in a case where a plurality of processings is included in one step, the plurality of processings included in the one step can be performed by one device or can be performed by a plurality of devices in a distributed manner.

<Example of Combination of Configurations>

Note that the present technology can also have the following configuration.

(1)

An information processing method including:

performing, by an information processing system including one or more information processing devices, training of a prediction model on the basis of prediction data used for predictive analysis using the prediction model and learning data.

(2)

The information processing method according to (1), in which

the information processing system

sets a weight for each of data samples included in the learning data on the basis of a relationship with the prediction data, and

performs the training of the prediction model on the basis of each of the data samples and the weight for each of the data samples.

(3)

The information processing method according to (2), in which

the information processing system sets the weight on the basis of a difference of a predetermined attribute between the data sample and the prediction data.

(4)

The information processing method according to (3), in which

the attribute sets the weight on the basis of a temporal difference between the data sample and the prediction data.

(5)

The information processing method according to any one of (1) to (4), in which

the information processing system

performs training of a plurality of the prediction models on the basis of each of a plurality of pieces of partial data in different ranges of the learning data,

calculates prediction accuracy of each of the prediction models by using a part of the learning data as virtual prediction data, and

sets a range of the learning data to be used for the training of the prediction model on the basis of the prediction accuracy of each of the prediction models.

(6)

The information processing method according to (5), in which

the information processing system

performs the training of each of the prediction models on the basis of each of a plurality of pieces of the partial data of different periods of the learning data, and

sets a period of the learning data to be used for the training of the prediction model on the basis of the prediction accuracy of each of the prediction models.

(7)

The information processing method according to any one of (1) to (4), in which

the information processing system

divides the learning data into a plurality of pieces of partial data,

calculates a degree of similarity between each piece of the partial data and the prediction data,

sets a weight for each piece of the partial data on the basis of the degree of similarity, and

performs the training of the prediction model on the basis of each piece of the partial data and the weight for each of the partial data.

(8)

The information processing method according to (7), in which

the information processing system divides the learning data into a plurality of pieces of the partial data of different periods.

(9)

The information processing method according to any one of (1) to (8), in which

the information processing system

generates the learning data on the basis of the prediction data, and

performs the training of the prediction model on the basis of the generated learning data.

(10)

The information processing method according to (9), in which

the information processing system sets a feature amount to be used for the learning data on the basis of the prediction data.

(11)

The information processing method according to any one of (1) to (10), in which

the information processing system selects a learning method based on the learning data and the prediction data or a learning method based on the learning data on the basis of the degree of similarity between the learning data and the prediction data to perform the training of the prediction model.

(12)

The information processing method according to any one of (1) to (10), in which

the information processing system selects a learning method based on the learning data and the prediction data or a learning method based on the learning data on the basis of a degree of similarity between a plurality of pieces of partial data in different ranges of the learning data to perform the training of the prediction model.

(13)

The information processing method according to (12), in which

the information processing system selects the learning method on the basis of a time-series change in degree of similarity between a plurality of pieces of the partial data of different periods of the learning data.

(14)

The information processing method according to any one of (1) to (10), in which

the information processing system

calculates prediction accuracy of a first prediction model by a learning method based on the learning data and the prediction data as well as prediction accuracy of a second prediction model by a learning method based only on the learning data by using a part of the learning data as the virtual prediction data, and

selects the learning method on the basis of the prediction accuracy of the first prediction model and the prediction accuracy of the second prediction model to perform the training of the prediction model.

(15)

The information processing method according to (14), in which

the information processing system selects the learning method on the additional basis of a time required for training of the first prediction model and a time required for training of the second prediction model.

(16)

An information processing device including:

a learning unit that performs training of a prediction model on the basis of prediction data used for predictive analysis using the prediction model and learning data.

(17)

A program for causing a computer to perform processing of:

performing training of a prediction model on the basis of prediction data used for predictive analysis using the prediction model and learning data.

(18)

An information processing method including:

performing, by an information processing system including one or more information processing devices, predictive analysis on the basis of a prediction model trained on the basis of learning data and prediction data, and the prediction data.

(19)

An information processing device including:

a prediction unit that performs predictive analysis on the basis of a prediction model trained on the basis of learning data and prediction data, and the prediction data.

(20)

A program for causing a computer to perform processing of:

performing predictive analysis on the basis of a prediction model trained on the basis of learning data and prediction data, and the prediction data.

(21)

An information processing method performed by an information processing system including one or more information processing devices, the information processing method including:

setting a weight for each of a plurality of prediction models trained on the basis of a plurality of pieces of partial data in different ranges of learning data, on the basis of a degree of similarity between the partial data corresponding to each of the prediction models and prediction data; and

performing predictive analysis on the basis of each of the prediction models, the weight for each of the prediction models, and the prediction data.

(22)

The information processing method according to (21), in which

each of the prediction models is trained on the basis of a plurality of pieces of the partial data of different periods of the learning data.

(23)

An information processing device including:

a prediction unit that sets a weight for each of a plurality of prediction models trained on the basis of a plurality of pieces of partial data in different ranges of learning data, on the basis of a degree of similarity between the partial data corresponding to each of the prediction models and prediction data, and performs predictive analysis on the basis of each of the prediction models, the weight for each of the prediction models, and the prediction data.

(24)

A program for causing a computer to perform processing of:

setting a weight for each of a plurality of prediction models trained on the basis of a plurality of pieces of partial data in different ranges of learning data, on the basis of a degree of similarity between the partial data corresponding to each of the prediction models and prediction data; and

performing predictive analysis on the basis of each of the prediction models, the weight for each of the prediction models, and the prediction data.

(25)

An information processing method including:

performing, by an information processing system including one or more information processing devices, training of each of a plurality of prediction models on the basis of a plurality of pieces of partial data in different ranges of learning data.

(26)

The information processing method according to (25), in which

the information processing system performs the training of each of the prediction models on the basis of a plurality of pieces of the partial data of different periods of the learning data.

(27)

An information processing device including:

a learning unit that performs training of each of a plurality of prediction models on the basis of a plurality of pieces of partial data in different ranges of learning data.

(28)

A program for causing a computer to perform processing of:

performing training of each of a plurality of prediction models on the basis of a plurality of pieces of partial data in different ranges of learning data.

Note that the effects described in the present specification are merely illustrative and not limitative, and the present technology may have other effects.

### REFERENCE SIGNS LIST

11 Information processing system
21 Customer/contract database
22 Learning processing unit
23 Prediction unit
24 UI unit
31 Data generation unit
32 Learning unit
41 Learning data generation unit
42 Prediction data generation unit

1. An information processing method comprising:
performing, by an information processing system including one or more information processing devices, training of a prediction model, on a basis of prediction data used for predictive analysis using the prediction model and learning data.

2. The information processing method according to claim 1, wherein
the information processing system
sets a weight for each of data samples included in the learning data on a basis of a relationship with the prediction data, and
performs the training of the prediction model on a basis of each of the data samples and the weight for each of the data sample.

3. The information processing method according to claim 2, wherein
the information processing system sets the weight on a basis of a difference of a predetermined attribute between the data sample and the prediction data.

4. The information processing method according to claim 3, wherein
the attribute sets the weight on a basis of a temporal difference between the data sample and the prediction data.

5. The information processing method according to claim 1, wherein
the information processing system
performs training of a plurality of the prediction models on a basis of each of a plurality of pieces of partial data in different ranges of the learning data,
calculates prediction accuracy of each of the prediction models by using a part of the learning data as virtual prediction data, and
sets a range of the learning data to be used for the training of the prediction model on a basis of the prediction accuracy of each of the prediction models.

6. The information processing method according to claim 5, wherein
the information processing system
performs the training of each of the prediction models on a basis of each of a plurality of pieces of the partial data of different periods of the learning data, and
sets a period of the learning data to be used for the training of the prediction model on a basis of the prediction accuracy of each of the prediction models.

7. The information processing method according to claim 1, wherein
the information processing system
divides the learning data into a plurality of pieces of partial data,
calculates a degree of similarity between each piece of the partial data and the prediction data,
sets a weight for each piece of the partial data on a basis of the degree of similarity, and
performs the training of the prediction model on a basis of each piece of the partial data and the weight for each of the partial data.

8. The information processing method according to claim 7, wherein
the information processing system divides the learning data into a plurality of pieces of the partial data of different periods.

9. The information processing method according to claim 1, wherein
the information processing system generates the learning data on a basis of the prediction data, and
performs the training of the prediction model on a basis of the generated learning data.

10. The information processing method according to claim 9, wherein
the information processing system sets a feature amount to be used for the learning data on a basis of the prediction data.

11. The information processing method according to claim 1, wherein
the information processing system selects a learning method based on the learning data and the prediction data or a learning method based on the learning data on a basis of a degree of similarity between the learning data and the prediction data to perform the training of the prediction model.

12. The information processing method according to claim 1, wherein
the information processing system selects a learning method based on the learning data and the prediction data or a learning method based on the learning data on a basis of a degree of similarity between a plurality of pieces of partial data in different ranges of the learning data to perform the training of the prediction model.

13. The information processing method according to claim 12, wherein
the information processing system selects the learning method on a basis of a time-series change in degree of similarity between a plurality of pieces of the partial data of different periods of the learning data.

14. The information processing method according to claim 1, wherein
the information processing system
calculates prediction accuracy of a first prediction model by a learning method based on the learning data and the prediction data as well as prediction accuracy of a second prediction model by a learning method based only on the learning data by using a part of the learning data as virtual prediction data, and
selects the learning method on a basis of the prediction accuracy of the first prediction model and the prediction accuracy of the second prediction model to perform the training of the prediction model.

15. The information processing method according to claim 14, wherein
the information processing system selects the learning method on an additional basis of a time required for training of the first prediction model and a time required for training of the second prediction model.

16. An information processing device comprising:
a learning unit that performs training of a prediction model, on a basis of prediction data used for predictive analysis using the prediction model and learning data.

17. A program for causing a computer to perform processing of:
performing training of a prediction model, on a basis of prediction data used for predictive analysis using the prediction model and learning data.
